(19) United States
(12) Patent Application Publication
(10) Pub. No.: US 2025/0218652 A1
(43) Pub. Date: Jul. 3, 2025

(54) CROSS-CONNECTED COUPLED INDUCTOR STRUCTURES

(71) Applicant: Intel Corporation, Santa Clara, CA (US)

(72) Inventors: Jagadish Vasudeva Singh, Bangalore (IN); Manikandan Murugesan, Bangalore (IN); Avinash Manu Aravindan, Alappuzha (IN); Rohit Parakkal, Bangalore (IN); Mahendra Reddy Kamireddy, Bangalore (IN); Sneha Yadav, Bangalore (IN)

(73) Assignee: Intel Corporation, Santa Clara, CA (US)

(21) Appl. No.: 19/083,069

(22) Filed: Mar. 18, 2025

Related U.S. Application Data
(60) Provisional application No. 63/669,473, filed on Jul. 10, 2024.

(51) Int. Cl. H01F 27/29; H01F 27/02

(52) U.S. Cl. CPC H01F 27/29; H01F 27/02

(57) ABSTRACT

Cross-connected coupled inductor structures are disclosed herein. An example coupled inductor includes an enclosure having a left section and a right section, a front surface opposite a back surface, and a top surface opposite a bottom surface, a first plane of the front and back surfaces orthogonal to a second plane of the top and bottom surfaces. The example coupled inductor also includes a first conductor having a first terminal proximate to an intersection of the bottom surface and the front surface of the right section of the enclosure, and a second terminal proximate to an intersection of the bottom surface and the back surface of the left section of the enclosure. The example coupled inductor also includes a second conductor having a third terminal proximate to an intersection of the bottom surface and the front surface of the left section of the enclosure, and a fourth terminal proximate to an intersection of the bottom surface and the back surface of the right section of the enclosure.

### RELATED APPLICATION

This patent claims the benefit of U.S. Provisional Patent Application No. 63/669,473, which was filed on Jul. 10, 2024. U.S. Provisional Patent Application No. 63/669,473 is hereby incorporated herein by reference in its entirety. Priority to U.S. Provisional Patent Application No. 63/669,473 is hereby claimed.

### BACKGROUND

Coupled inductors benefit multiphase switching regulators by improving transient performance over the legacy inductors (uncoupled) while reducing the output capacitance, which may be achieved through non-linear inductance.

### BRIEF DESCRIPTION OF THE DRAWINGS

FIG. 1 is a block diagram of an example coupled inductor structure to achieve inverse coupling with an opposite-side driver orientation.

FIG. 2 is a block diagram of an example system-on-chip (SoC) that includes the example coupled inductor structure of FIG. 1 to achieve inverse coupling with opposite-side drivers.

FIG. 3 is an example printed circuit board (PCB) layout of four (4) coupled inductor structures of FIG. 1.

FIG. 4A is a block diagram of an example coupled inductor structure to reduce space consumption with inverse coupling.

FIG. 4B is a block diagram of an alternative geometry of the coupled inductor structure of FIG. 4A to reduce space consumption with inverse coupling.

FIG. 5 is a block diagram of an example SoC layout that includes the example coupled inductor structure of FIGS. 4A or 4B to achieve inverse coupling with same-side drivers.

FIG. 6A is an isometric block diagram of an example coupled inductor structure to facilitate inverse coupling with same-side drive circuitry.

FIG. 6B is a two-dimensional top-view diagram of the coupled inductor structure of FIG. 6A to facilitate inverse coupling with same-side drive circuitry.

FIG. 7A is an isometric block diagram of an example coupled inductor structure to facilitate inverse coupling with same-side drive circuitry.

FIG. 7B is a two-dimensional block diagram of the coupled inductor structure of FIG. 7A to facilitate inverse coupling with same-side drive circuitry.

FIGS. 8A and 8B are charts of example coupling coefficients for example phase inductance values operating at a 600 kHz frequency at 150 nH and 65 nH.

FIGS. 9A through 9C are plots of the example coupling coefficients of FIGS. 8A and 8B.

FIG. 10 is a block diagram of an example helical shaped inductor structure.

FIG. 11 is a block diagram of another example coupled inductor with a coiled structure consistent with facilitation of inverse coupling with same-side drive circuitry disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

System-on-chip (SoC) systems typically use multiphase regulators to assist with the delivery of high currents at low voltage levels. This requires current sharing, component tolerance management (e.g., improving immunity to tolerance deviations), and ideally reduced complexity associated with current control. In such designs, an ideal inductor is one that exhibits high inductance during static current loading, thus being able to reduce current ripple and associated power losses, while being able to exhibit low inductance during transients so that the regulator can respond fast to such transients without needing a large number of bulk capacitors. This kind of non-linear inductor can be achieved when the coupled inductors are arranged in an inverse structure, as described in further detail below.

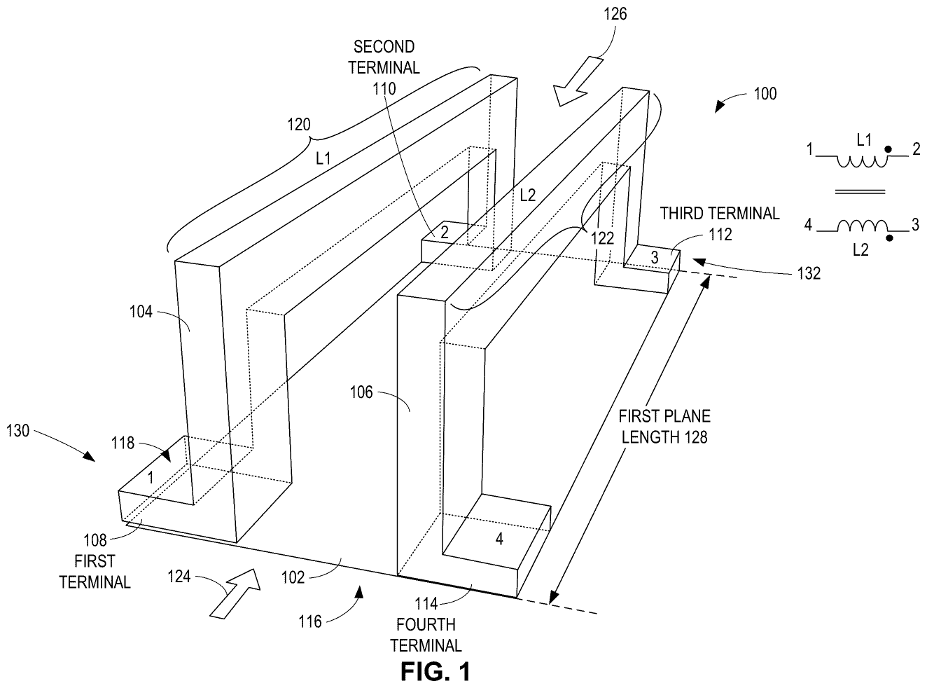

FIG. 1 is a block diagram of a coupled inductor structure 100 to achieve inverse coupling with an opposite-side driver orientation. In the illustrated example of FIG. 1, the coupled inductor structure 100 includes a base plane 102, a first conductor 104, and a second conductor 106. The example base plane 102 of the coupled inductor structure 100 is defined between a first side 124 and a second side 126 opposite to the first side 124, in which the coupled structure includes a first plane length 128 therebetween.

The example first conductor 104 includes a first terminal (sometimes referred to herein as a “pin”) 108 and a second terminal 110. The example second conductor 106 includes a third terminal 112 and a fourth terminal 114. The example first terminal 108, second terminal 110, third terminal 112 and fourth terminal 114 include an electrically conductive surface to permit current to flow through the conductor from the board. In some examples, the electrically conductive surface of the first terminal 108 is located on a bottom side 116 of the base plane 102. In some examples, the electrically conductive surface of the first terminal 108 is located on a top side 118 of the first terminal 108. In some examples, the electrically conductive surface of the first terminal 108 is located on any other portion or surface thereof, without limitation. Similar electrically conductive surfaces may be included on the example second terminal 110, the example third terminal 112, and/or the example fourth terminal 114. The example first conductor 104 includes a first mutual inductance section 120 and the example second conductor 106 includes a second mutual inductance section 122, both of which span across the first plane length 128 and parallel to each other. In some cases, based on design, the mutual inductance sections 120 and 122 may extend to the vertical sections of the conducting structures 104 and 106.

In operation, a current injected through and/or otherwise provided to (referred to herein as “driven”) a terminal (e.g., the first terminal 108) of the first conductor 104 exhibits a particular self-inductance value that is a function of a geometry (e.g., length, width, height, circumference, characteristics of the core-material surrounding it) of the first conductor 104, and a type of material with which the first conductor 104 is made. In the illustrated example of FIG. 1, the first terminal 108 is a driver terminal 130 of the first conductor 104. Similarly, an input driven to a terminal (e.g., the third terminal 112) of the second conductor 106 exhibits a particular self-inductance value that is a function of a geometry of the second conductor 106 and a type of material with which the second conductor 106 is made. In the illustrated example of FIG. 1, the third terminal 112 is a driver terminal 132 of the second conductor 106. However, the example coupled inductor structure 100 exhibits a particular mutual inductance value when an input is driven to both the first conductor 104 and the second conductor 106 at the same time. Additionally, to achieve inverse coupling, an input is driven to the example first terminal 108 and the example third terminal 112.

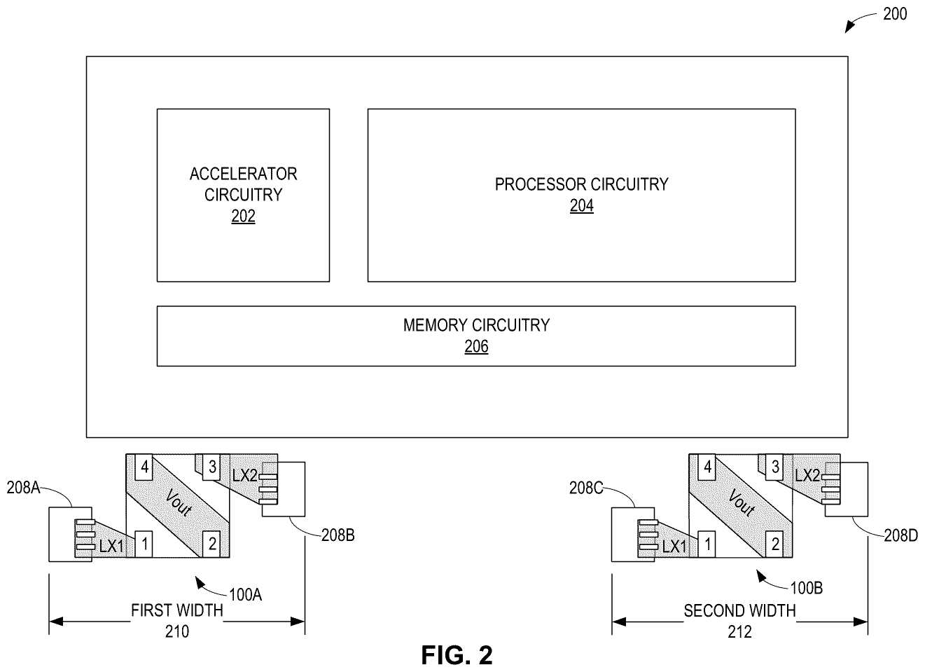

In some examples, drive circuitry to drive one or more terminals includes driver metal oxide field effect transistors (MOSFETs). In connection with efforts to reduce circuit board layout size and reduce interference phenomenon related to conductor length, driver MOSFET (DrMOS) and/or other driver circuitry is located as close as possible to one or more terminals to be driven. As used herein, a “driver circuit” or “driver circuitry” are referred to as a convenience for purposes of explanation, and include DrMOS-based drivers, but examples disclosed herein are not limited thereto. As such, a first driver is located proximate to the first terminal 108, and a second driver is located proximate to the third terminal 112. Unfortunately, such an arrangement results in a relatively greater consumed area of a circuit board that employs the example coupled inductor structure 100, as illustrated in FIG. 2.

FIG. 2 is a block diagram of an example SoC 200 that includes the coupled inductor structure 100 of FIG. 1. In the illustrated example of FIG. 2, the SoC 200 includes example accelerator circuitry 202, example processor circuitry 204, example memory circuitry 206, and an example first driver circuit 208A and an example second driver circuit 208B to drive a first coupled inductor structure 100A, and an example third driver circuit 208C and an example fourth driver circuit 208D to drive a second coupled inductor structure 100B. In some examples, the driver circuits are referred to herein as driver source(s). In operation, the first coupled inductor structure 100A and the second coupled inductor structure 100B are driven to achieve inverse coupling. In particular, the first coupled inductor structure 100A is driven at terminal 1 by the first driver circuit 208A and driven at terminal 3 by the second driver circuit 208B. Similarly, the second coupled inductor structure 100B is driven at terminal 1 by the third driver circuit 208C and driven at terminal 3 by the fourth driver circuit 208D. Because the first driver circuit 208A and the second driver circuit 208B are located on opposite sides of the example first coupled inductor structure 100A, an overall first width 210 occupies any underlying platform and/or PCB. Similarly, because the third driver circuit 208C and the fourth driver circuit 208D are located on opposite sides of the example second coupled inductor structure 100B, an overall second width 212 occupies any underlying platform and/or PCB. Examples disclosed herein reduce a size and/or otherwise consumed area of a coupled inductor structure based implementation, such as a reduction in the first width 210 and second width 212 of known coupled inductor structures based implementations that achieve inverse coupling during operation.

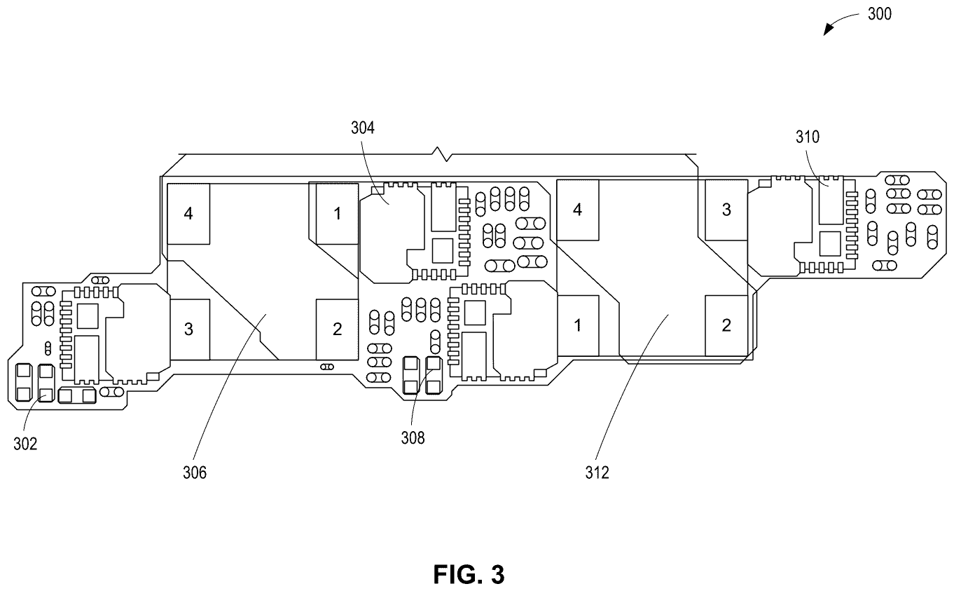

FIG. 3 is an example PCB layout 300 of known implementations of coupled inductor structures to achieve inverse coupling. In the illustrated example of FIG. 3, the PCB layout 300 includes a first driver circuit 302 and a second driver circuit 304 to drive a first coupled inductor 306. The illustrated example of FIG. 3 also includes a third driver circuit 308 and a fourth driver circuit 310 to drive a second coupled inductor 312. To achieve inverse coupling, the driver circuits of FIG. 3 are arranged at terminals in a manner that reduces or avoids long conductive PCB traces. However, such arrangements lack a degree of space conservation, thereby resulting in a consumed area of the PCB layout 300 that is larger than examples disclosed herein. Generally speaking, at least one benefit of examples disclosed herein is an ability to arrange driver circuitry in a manner that reduces an amount of surface area consumed by coupled inductors.

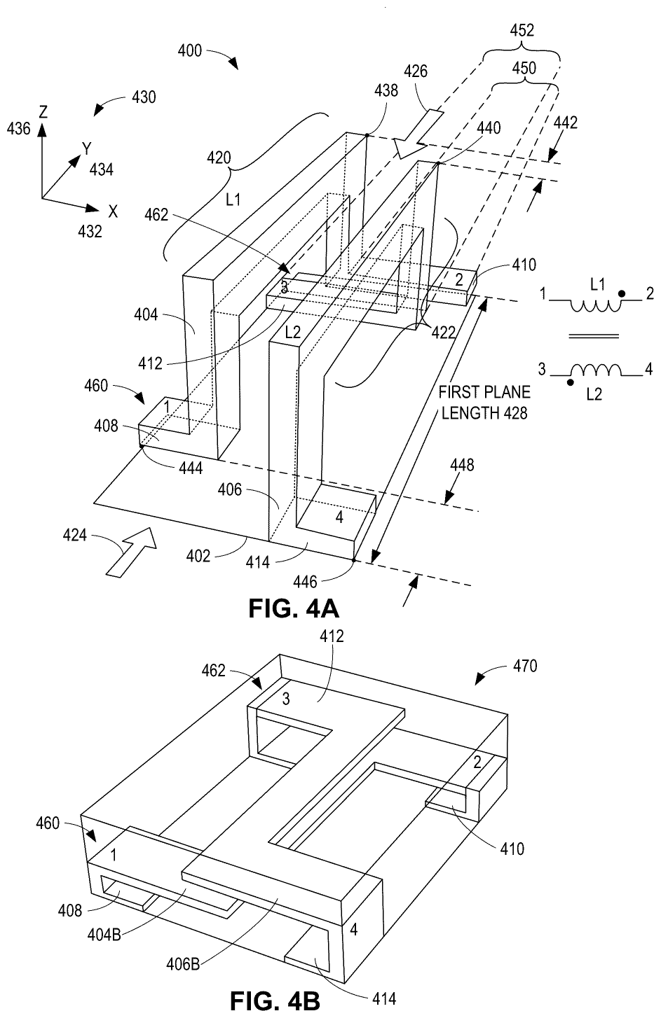

FIG. 4A is a block diagram of an example coupled inductor structure 400 to reduce space consumption and reduce conductive routing from driver circuitry to inductor terminals (e.g., “LX terminals”) to achieve inverse coupling. The illustrated example of FIG. 4A will be described with some structure similar to that of FIG. 1 for ease of reference, in which an example cartesian coordinate orientation 430 includes an x-axis 432, a y-axis 434 and a z-axis 436. In the illustrated example of FIG. 4A, the coupled inductor structure 400 includes a base plane 402, a first conductor 404, and a second conductor 406. Structural details of the first conductor 404 and the second conductor 406 are described below in further detail to distinguish from conductors described above in FIG. 1. The example first conductor 404 of FIG. 4A includes a first mutual inductance section 420, and the example second conductor 406 includes a second mutual inductance section 422 that is parallel to the first mutual inductance section 420. In some examples, the first mutual inductance section 420 and the second mutual inductance section 422 have the same length along the y-axis 434. In some examples, the first mutual inductance section 420 and the second mutual inductance section 422 are referred to as being horizontally adjacent (e.g., an x-axis frame of reference) to each other, and separated by a gap (e.g., a distance in mm).

The example base plane 402 establishes a first plane (e.g., along the x-y plane 432-434) of the coupled inductor structure 400 defined between a first side 424 and a second side 426, and the coupled structure 400 having a first plane length 428 therebetween. The example first conductor 404 includes a first terminal 408 and a second terminal 410, and the example second conductor 406 includes a third terminal 412 and a fourth terminal 414. While the first terminal 408 and the third terminal 412 of FIG. 4A are located in a manner substantially similar to the first terminal 108 and the second terminal 110 of FIG. 1, because of the alternate geometry of the example first conductor 404 and the example second conductor 406 of FIG. 4A, corresponding locations of the second terminal 410 and the fourth terminal 414 are different than those shown in the illustrated example of FIG. 1.

In the illustrated example of FIG. 4A, the first mutual inductance section 420 of the first conductor 404 extends along the first plane length 428 to a first endpoint location 438. On the other hand, the second mutual inductance section 422 of the second conductor 406 extends along the first plane length 428 to a second endpoint location 440. In the illustrated example of FIG. 4A, the first endpoint location 438 extends further along the first plane length 428 as compared to the second endpoint location 440. A difference between the first endpoint location 438 and the second endpoint location 440 represents an endpoint extension distance 442 in which a portion of the first conductor 404 extends beyond a portion of the second conductor 406.

In the illustrated example of FIG. 4A, the first mutual inductance section 420 of the first conductor 404 originates at a first start point location 444 and thereafter extends along the first plane length 428 to the first endpoint location 438. On the other hand, the second mutual inductance section 422 of the second conductor 406 originates at a second start point location 446 and thereafter extends along the first plane length 428 to the second endpoint location 440. A difference between the first start point location 444 and the second start point location 446 represents a start point extension distance 448, in which a portion of the second conductor 406 extends beyond the first start point location 444 of the first conductor 404. Stated differently, the example first conductor 404 and the example second conductor 406 of FIG. 4A are staggered and/or otherwise offset from each other. In some examples, the endpoint overlap distance 442 and the start point overlap distance 448 are equal.

The example start point overlap distance 448 and endpoint overlap distance 442 facilitate spatial room relative to the base plane 402 of the coupled inductor structure 400 for a first crossover section 450 of the first conductor 404, and a second crossover section 452 of the second conductor 406. As shown in the illustrated example of FIG. 4A, while the first terminal 408 of the first conductor 404 is located on a left side of the example inductor structure 400, because of the second crossover section 452 of the second conductor 406 the third terminal 412 is also located on the left side of the example inductor structure 400. The first terminal 408 is a driver terminal 460 of the first conductor 404, and the third terminal 412 is a driver terminal 462 of the second conductor 406. As such, both the first conductor 404 and the second conductor 406 may be driven in an inversely coupled manner with all driver circuitry also located proximate to the left side. Stated differently, because both LX terminals (e.g., the first terminal 408 and the third terminal 412) are located on the left side of the inductor structure 400, the corresponding driver circuitry may also be located proximate to the left side to consolidate an amount of area consumed by such driver circuitry. As such, the first crossover section 450 is coupled to the second terminal 410, which is located diagonally opposite the first terminal 408 on the driver side of the inductor structure 400. Additionally, the second crossover section 452 is coupled to the third terminal 412, which is located diagonally opposite the fourth terminal 414.

FIG. 4B is a block diagram of an example coupled inductor structure 470 to reduce space consumption and reduce conductive routing from driver circuitry to LX terminals. While the illustrated example of FIG. 4A includes the first conductor 404 and the second conductor 406 having a particular orthogonal profile arranged next to each other and separated by an x-axis 432 gap therebetween, the illustrated example of FIG. 4B includes an alternative orthogonal profile. In particular, the illustrated example of 4B includes a first conductor 404B and a second conductor 406B having an alternate orthogonal profile arranged over each other and separated by a z-axis 436 gap therebetween. The first conductor 404B includes the driver terminal 460 (e.g., the first terminal 408), and the second conductor 406B includes the driver terminal 462 (e.g., the third terminal 412). In some examples, mutual inductance sections of the illustrated example of FIG. 4B are referred to as having a vertical adjacency (e.g., a z-axis frame of reference). Additionally, while the illustrated examples of FIGS. 4A and 4B include conductors having a substantially orthogonal profile, examples disclosed herein are not limited thereto. In some examples, the conductors may have a circular profile (e.g., wire) and/or any other profile with straight, curved and/or twisted paths. Additionally, while the illustrated examples of FIGS. 4A and 4B include a coupled inductor structure 400 forming a substantially orthogonal shape with a base plane 402, examples disclosed herein are not limited thereto. In some examples, coupled inductor structures may exhibit a toroidal shape and/or otherwise circular shape.

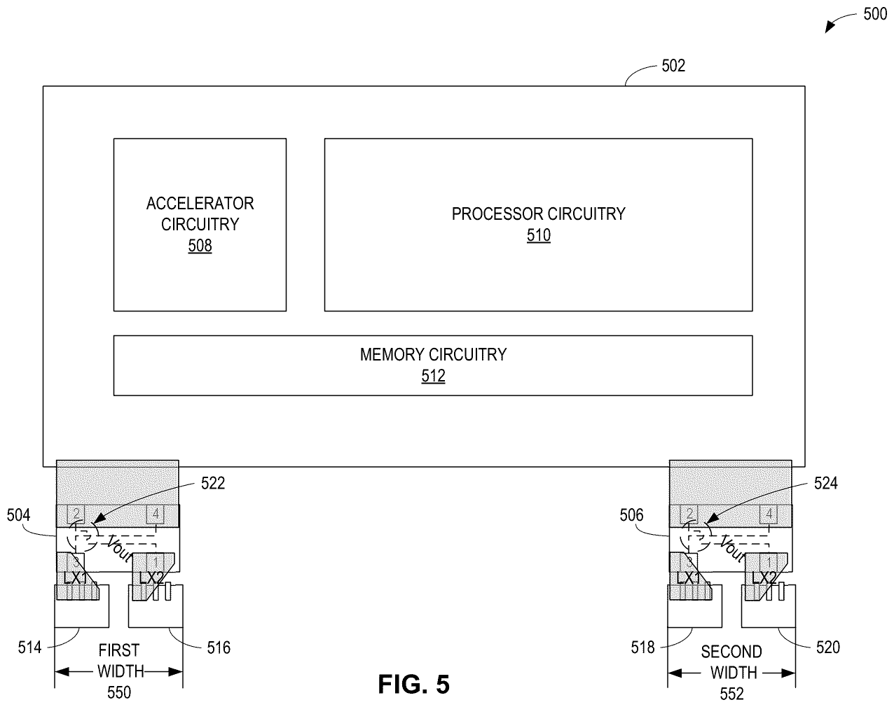

FIG. 5 is a block diagram of an example environment 500 (e.g., an SoC layout) including two example coupled inductor structures. In the illustrated example of FIG. 5, the environment 500 includes a computing platform 502, a first coupled inductor structure 504, and a second coupled inductor structure 506. While the illustrated example of FIG. 5 includes two coupled inductor structures, examples disclosed herein are not limited thereto. The example computing platform 502 may include any type and/or number of computing devices therein, such as example accelerator circuitry 508, example processor circuitry 510, and example memory circuitry 512. The example first coupled inductor structure 504 includes first driver circuitry 514, second driver circuitry 516, and a first crossover section 522. Similarly, the example second coupled inductor structure 506 includes third driver circuitry 518, fourth driver circuitry 520, and a second crossover section 524. The example first crossover section 522 is substantially similar to the first crossover section 450 and the second crossover section 452 described above in connection with FIG. 4A.

Using the example first coupled inductor structure 504 for purposes of discussion, the conductor arrangement is similar to the example coupled inductor structure 400 of FIGS. 4A and 4B. In particular, the first driver circuitry 514 drives an inductive conductor between terminal 3 and terminal 4. Additionally, the second driver circuitry 516 drives an inductive conductor between terminal 1 and terminal 2. Because of the example first crossover section 522 both the first driver circuitry 514 and the second driver circuitry 516 are located on the same side of the first coupled inductor structure 504. Stated differently, the first coupled inductor structure 504 may be driven in an inversely coupled manner while permitting both driver circuits to reside on the same side, thereby conserving scarce space resources in any applied electrical and/or electronic environment. In particular, and in comparison with the illustrated example of FIG. 2, a first width 550 of the example first coupled inductor structure 504 of FIG. 5 is less than the first width 210 of the example first coupled inductor structure 100A of FIG. 2. Similarly, a second width 552 of the example second coupled inductor structure 506 of FIG. 5 is less than the second width 212 of the example second coupled inductor structure 100B of FIG. 2. As such, examples disclosed herein facilitate space saving capabilities.

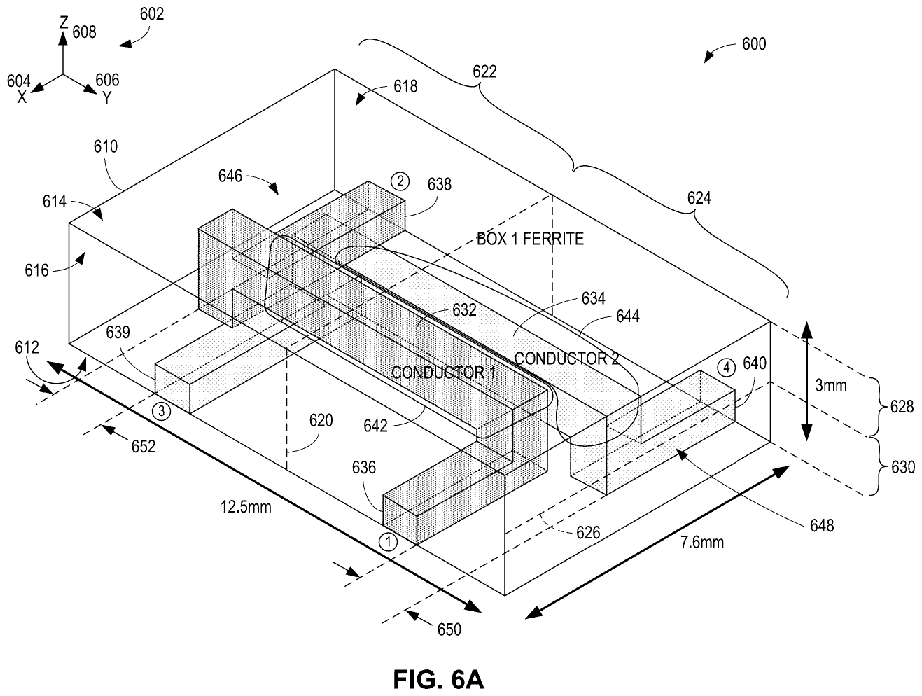

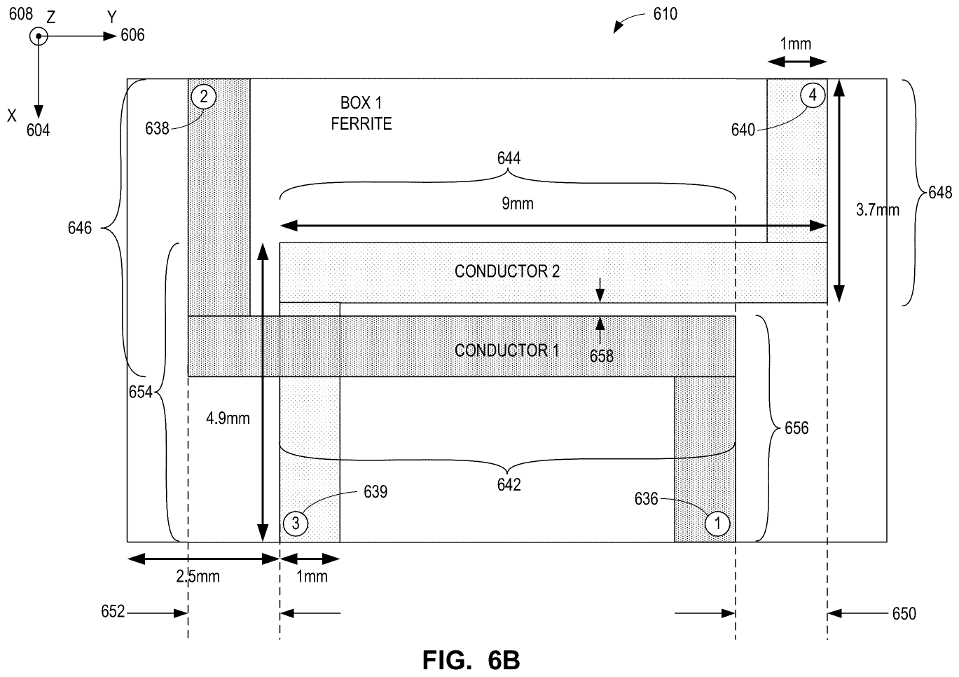

FIG. 6A is a block diagram of an example coupled inductor structure 600 to facilitate inverse coupling (e.g., inverse magnetic coupling) of conductors with same-side drive circuitry. The illustrated example of FIG. 6A includes a cartesian coordinate orientation 602, which includes an x-axis 604, a y-axis 606 and a z-axis 608. While the illustrated example of FIG. 6A represents an orthogonal coupled inductor structure 600, examples disclosed herein are not limited thereto, and radial or helix-based structures may be considered. The coupled inductor structure 600 includes an enclosure 610, in which the enclosure 610 includes a bottom surface 612, a top surface 614, a front surface 616, a back surface 618, a y-axis centerline 620 that defines a left section 622 and a right section 624, and an z-axis centerline 626 that defines a top section 628 and a bottom section 630. The example front surface 616 and back surface 618 align with a first plane, and the example top section 628 and bottom section 630 align with a second plane, the first plane and the second plane orthogonal to each other. In some examples, the enclosure 610 is a device, package, or chip having a ferrite material that surrounds, encloses and/or otherwise encapsulates two or more conductors, as described above and in further detail below. In some examples, the enclosure 610 is a device that is electrically connected to (e.g., via soldering) a PCB (e.g., a PCB having devices/components corresponding to a circuit).

The coupled inductor structure 600 of FIG. 6A includes a first conductor 632 and a second conductor 634. The example first conductor 632 forms a first path through the enclosure 610 beginning at a first terminal 636 and ending at a second terminal 638. The first terminal 636 is located proximate to an intersection of the bottom surface 630 and the front surface 616 on the right section 624 of the enclosure 610. Additionally, the first terminal 636 and the second terminal 638 include a conductive interface to facilitate electrical conductivity (e.g., LX terminals electrically connected to driver circuitry on one side and capacitors on the other, etc.). The second terminal 638 is located proximate to an intersection of the bottom surface 630 and the back surface 618 on the left section 622 of the enclosure 610.

The example second conductor 634 of FIG. 6A forms a second path through the base enclosure 610 beginning at a third terminal 639 and ending at a fourth terminal 640. The third terminal 639 is located proximate to an intersection of the bottom surface 630 and the front surface 616 on the left section 622 of the enclosure 610. Additionally, the third terminal 639 and the fourth terminal 640 include a conductive interface to facilitate electrical conductivity. The fourth terminal 640 is located proximate to an intersection of the bottom surface 630 and the back surface 618 on the right section 624 of the base enclosure. The first terminal 636 is sometimes referred to as a driver terminal for the first conductor 632, and the third terminal 639 is sometimes referred to as a driver terminal for the second conductor 634. As such, the example coupled inductor structure 600 of FIG. 6A facilitates the ability to orient driver circuitry on a same and/or otherwise common side.

The first conductor 632 and the second conductor 634 do not connect and/or otherwise intersect physically, but each conductor exhibits a self inductance characteristic based on its physical and/or material characteristics. Additionally, in the event current is driven into both the first conductor 632 and the second conductor 634 substantially simultaneously, a corresponding mutual inductance characteristic occurs. The first conductor 632 includes a first mutual inductance section 642 and the second conductor 634 includes a second mutual inductance section 644, in which the first mutual inductance section 642 and the second mutual inductance section 644 have lengths and are located parallel to each other along the y-axis 606 in the top section 628. The first mutual inductance section 642 and the second mutual inductance section 644 are separated by a gap having a distance value. In some examples, a particular gap distance value causes the first mutual inductance section 642 and the second mutual inductance section 644 to exhibit a corresponding mutual inductance value during operation. Mutual inductance values are also a function of overlap between the first mutual inductance section 642 and the second mutual inductance section 644. In some examples, a type of ferrite or any other core material affects the mutual inductance values. Generally speaking, any number, type and/or combination of distance gap, overlap, conductor geometry, and the like may be implemented by examples disclosed herein to accommodate for particular use cases.

To permit the first conductor 632 and the second conductor 634 to be routed through the base enclosure 610 without physical intersection, the first conductor 632 includes a first crossover section 646 and the second conductor 634 includes a second crossover section 648. Because the first mutual inductance section 642 and the second mutual inductance section 644 are routed through the top section 628, they are conductively connected to the first crossover section 646 and the second crossover section 648, respectively, in an “L” shape that reaches the bottom section 630. Stated differently, respective crossover sections enable a connector that originates on the front surface 616 to terminate on the back surface 618, and vice versa. Additionally, to prevent physical intersection between the conductors, the first terminal 636 of the first conductor 632 is placed in the enclosure 610 to avoid overlap with the fourth terminal 640 of the second conductor 634, thereby creating a right section overlap distance 650. Similarly, the third terminal 639 of the second conductor 634 is placed in the enclosure 610 to avoid overlap with the second terminal 638 of the first conductor 632, thereby creating a left section overlap distance 652.

In operation, the example coupled inductor structure 600 of FIG. 6A is driven by driver circuitry at the first terminal 636 and the third terminal 639 to achieve inverse coupling. In some examples, the driver circuitry includes first driver circuitry 514 to drive the first terminal 636 and second driver circuitry 516 to drive the third terminal 639 such that both the first driver circuitry 514 and second driver circuitry 516 reside on the same side of the enclosure 610 (e.g., along the front surface 616 of the enclosure 610). Accordingly, examples disclosed herein enable components (e.g., driver circuitry) to be placed on a layout (e.g., a circuit board layout) in a manner that consumes less area as compared to known approaches where driver circuitry resides on opposite sides of the enclosure 610.

FIG. 6B is a top-view diagram of the enclosure 610 of FIG. 6A. In particular, the enclosure 610 of FIG. 6B represents a two-dimensional view along the x-axis 604 and the y-axis 606. The illustrated example of FIG. 6B is included to permit an alternate view of the enclosure 610, to include example dimension values, and to better identify various structural features of the example enclosure 610 of FIG. 6A. The illustrated example of FIG. 6B includes the example right section overlap distance 650, the example left section overlap distance 652, the example first crossover section 646, the example second crossover section 648, an example third crossover section 654, and a fourth crossover section 656. The illustrated example of FIG. 6B includes the first mutual inductance section 642 and its overlapping counterpart second mutual inductance section 644 separated by a gap 658. As described above, the gap 658 may have varying distance/width values that have an effect on target mutual inductance characteristics of the example enclosure 610 when driven in an inverse coupled manner.

In some examples, the first terminal 636, the second terminal 638, the third terminal 639 and the fourth terminal 640 are spatially arranged to satisfy and/or otherwise accommodate industry standard dimensions for circuit board placement/mounting. In some examples, the terminals are spatially arranged to align with solder points of a circuit board. In some examples, the geometries, materials, path overlaps of the first conductor 632 and the second conductor 634, and the gap distance 658 of FIGS. 6A and 6B are selected to achieve a self inductance of approximately 150 nH and a mutual inductance of approximately 65 nH, but other values apply to examples disclosed herein.

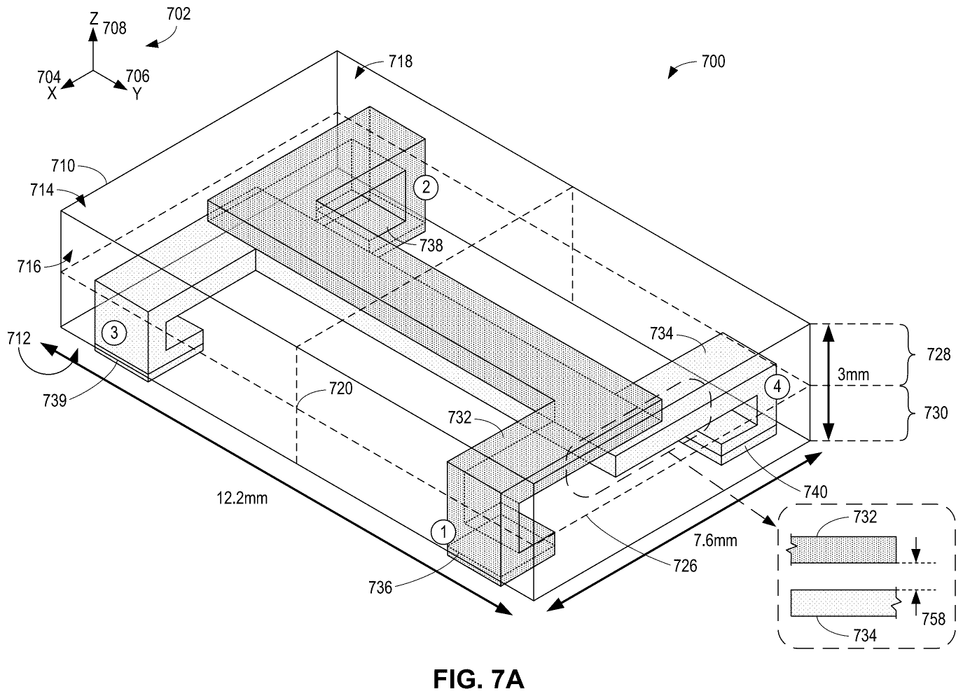

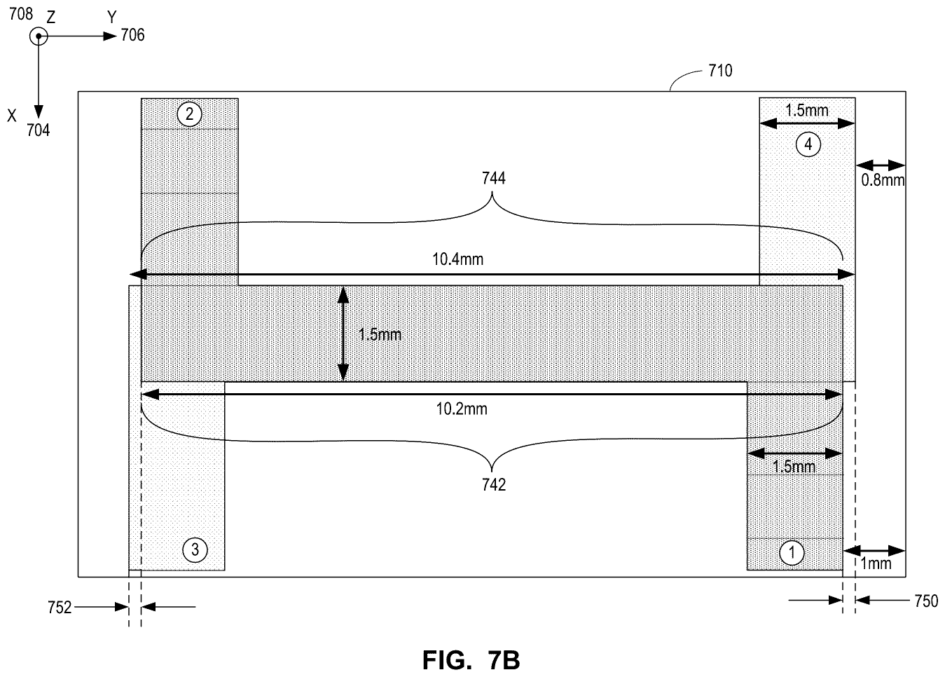

FIG. 7A is a block diagram of an example coupled inductor structure 700 to facilitate inverse coupling (e.g., inverse magnetic coupling) of conductors with same-side drive circuitry. The illustrated example of FIG. 7A includes reference numbers substantially similar to reference numbers shown in FIG. 6A, but with a “700” series designation (e.g., element 602 of FIG. 6A refers to similar structure and/or concepts as element 702 of FIG. 7A). As such, an emphasis on particular differences between the illustrated examples of FIG. 6A and FIG. 7A will follow.

While in the illustrated examples of FIG. 6A and 6B, the first mutual inductance section 642 and the second mutual inductance section 644 overlap along the y-axis 606, examples disclosed herein are not limited thereto. In the illustrated example of FIG. 7A, the first mutual inductance section 742 of the first conductor 732 overlaps with the second mutual inductance section 744 of the second conductor 734 along the z-axis 708. Stated differently, the first mutual inductance section 742 of FIG. 7A is above and/or otherwise on top of the second mutual inductance section 744. In some examples, a z-axis gap 758 is formed between the mutual inductance sections having a particular distance value (see exploded side view of the first conductor 732 and the second conductor 734 separated by the gap 758).

The example first conductor 732 and the example second conductor 734 of FIG. 7A represent an alternate geometrical profile than the first conductor 632 and the example second conductor 634 of FIG. 6A. In particular, the example conductors of FIG. 7A (and 7B) may include a profile having a relatively shorter dimension along the z-axis 708. Other geometrical profiles may be realized by examples disclosed herein.

FIG. 7B is a schematic diagram of the enclosure 710 of FIG. 7A. In particular, the enclosure 710 of FIG. 7B represents a two-dimensional view along the x-axis 704 and the y-axis 706. In the illustrated example of FIG. 7B, the right section overlap distance 750 and the left section overlap distance 752 are substantially smaller/shorter than the right section overlap distance 650 and the left section overlap distance 652 of FIG. 6B. In some cases, the overlap distance of 750 and 752 may be non-existent. Additionally, while an example y-axis 606 dimension of the first conductor 632 and the second conductor 634 of FIGS. 6A and 6B is shown as 1 mm, the y-axis 706 dimension of the first conductor 732 and the second conductor 734 of FIGS. 7A and 7B has a relatively larger value of 1.5 mm. Examples disclosed herein are not limited to dimensions shown in FIGS. 6A, 6B, 7A and/or 7B.

In some examples, the geometries, materials, path overlaps of the first conductor 732 and the second conductor 734, and the gap distance 758 of FIGS. 7A and 7B are selected to achieve a self inductance of approximately 150 nH and a mutual inductance of approximately 65 nH, but other values apply to examples disclosed herein. In some examples, because the illustrated examples of FIGS. 7A and 7B exhibit a greater degree of symmetry (e.g., less spatial overshoot along the y-axis), a correspondingly lower amount of inductance variation is exhibited by the conductors.

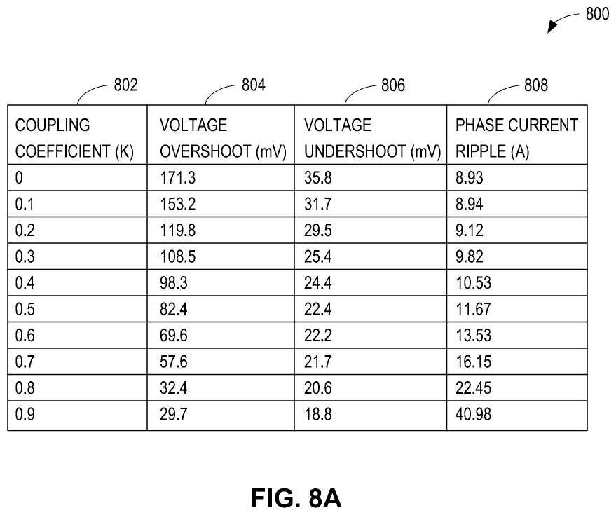

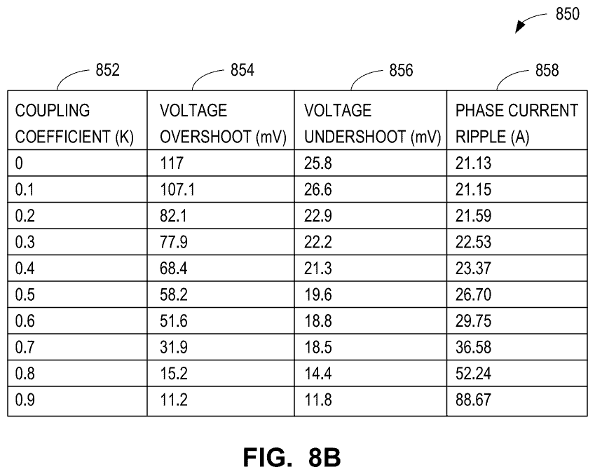

FIG. 8A is a chart 800 of example coupling coefficients for a phase inductance of 150 nH while operating at a 600 kHz frequency. The chart 800 of FIG. 8A includes a coupling coefficient column 802, a voltage overshoot column 804, a voltage undershoot column 806, and a phase current ripple column 808. Values in the chart 800 are derived from modeling simulations (e.g., simulation of piecewise linear systems) for two phases (e.g., one phase corresponds to current driven in a first conductor, a second phase corresponds to current driven in a second conductor) that are inversely coupled with each phase having a phase inductance of 150 nH. The amount of coupling between two phase conductors is expressed in terms of coupling coefficient, the value of which is varied from zero (no coupling) to 0.9 (referred to as “tight coupling”) in the simulation to measure the corresponding voltage overshoot values, voltage undershoot values, and phase current ripple values during the load transient events.

In the illustrated example of FIGS. 8A and 8B, voltage overshoot and voltage undershoot values are separately captured for various coupling coefficients, starting at zero (no coupling). Particular values were captured at step-wise iterations in which the coupling coefficient is increased (e.g., by a value of 0.1). At each iterative step, a corresponding overshoot, undershoot and phase current ripple value was obtained. As coupling is increased between two conductors, corresponding overshoot and undershoot values decrease, thereby improving transient performance characteristics. However, in terms of per-phase current ripple, increases in coupling corresponding to increases in ripple, which corresponds to a decrease in efficiency. Accordingly, such characteristics result in a tradeoff to be considered during implementation specific circumstances.

As shown in the illustrated example of FIG. 8A, relatively low coupling coefficient values result in relatively high voltage overshoot phenomenon, which is typically undesirable during inductor operation. However, such relatively low coupling coefficient values result in relatively low voltage undershoot phenomenon and relatively low phase current ripple values, both of which are typically desirable during inductor operation. As such, because both extreme coefficient values result in both desirable and undesirable phenomenon, a compromise coefficient value of 0.4 to 0.5 is typically deemed acceptable (e.g., optimized) for inductor operation. In some examples, a selected and/or otherwise derived coefficient value is referred to as an “optimized” coefficient value based on target performance characteristics for an end-use case of the inductor. For instance, in some examples where voltage overshoot is problematic for a first end-use case of the inductor, while the first end-use case is tolerant to phase current ripple, then an optimized coefficient value may be biased to a relatively higher value. Conversely, an example second end-use case may be tolerant to relatively higher voltage overshoot, but may also be sensitive to phase current ripple. In such cases, an optimized coefficient value may be biased to a relatively lower value.

FIG. 8B is a chart 850 of example coupling coefficients for a phase inductance of 65 nH while operating at a 600 kHz frequency. The chart 850 of FIG. 8B includes a coupling coefficient column 852, a voltage overshoot column 854, a voltage undershoot column 856, and a phase current ripple column 858. Values in the chart 850 are derived from modeling simulations (e.g., simulation of piecewise linear systems) for two phases (e.g., one phase corresponds to current driven in a first conductor, a second phase corresponds to current driven in a second conductor) that are inversely coupled. Similar to the performance observations described above in connection with FIG. 8A, because both extreme coefficient values result in both desirable and undesirable phenomenon, a compromise coefficient value of 0.4 to 0.5 is typically deemed acceptable (e.g., optimized) for inductor operation.

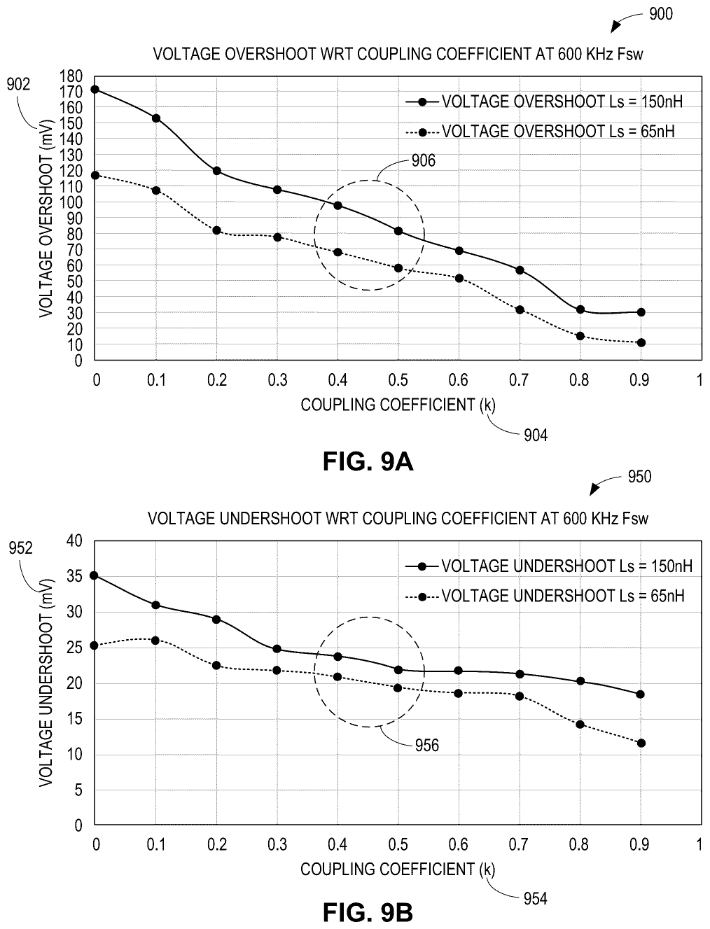

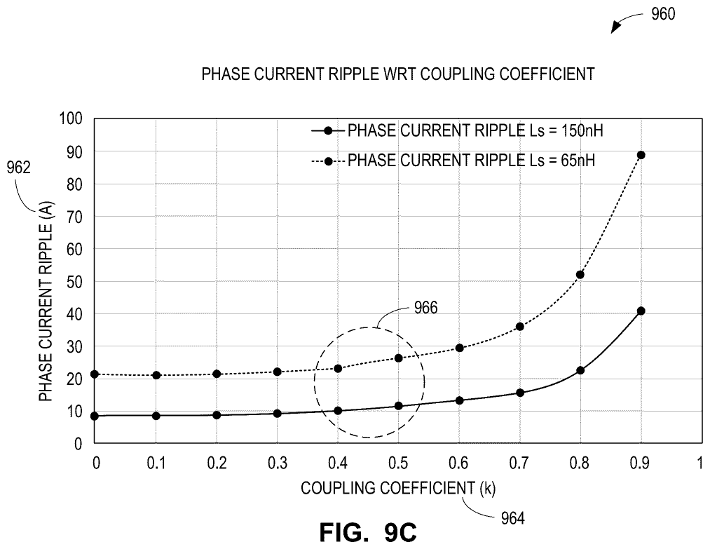

FIG. 9A is a plot 900 of voltage overshoot values 902 corresponding to respective coefficient values 904. Data points of the overshoot values from the voltage overshoot column 804 of FIG. 8A and values from the voltage overshoot column 854 of FIG. 8B are plotted for respective 150 nH and 65 nH phase inductance targets at 600 kHz. As described above, target coefficient values 906 illustrate a compromised target range. However, and as described above, alternate coefficient values may be selected and/or otherwise derived to achieve an “optimized” value based on, for example, a particular end-use scenario.

FIG. 9B is a plot 950 of voltage undershoot values 952 corresponding to respective coefficient values 954. Data points of the undershoot values from the voltage undershoot column 806 of FIG. 8A and values from the voltage undershoot column 856 of FIG. 8B are plotted for respective 150 nH and 65 nH phase inductance targets at 600 kHz. As described above, target coefficient values 956 illustrate a compromised target range. However, and as described above, alternate coefficient values may be selected and/or otherwise derived to achieve an “optimized” value based on, for example, a particular end-use scenario.

FIG. 9C is a plot 960 of phase current ripple values 962 corresponding to respective coefficient values 964. Data points of the phase current ripple values from the phase current ripple column 808 of FIG. 8A and values from the phase current ripple column 858 of FIG. 8B are plotted for respective 150 nH and 65 nH phase inductance targets at 600 kHz. As described above, target coefficient values 966 illustrate a compromised target range.

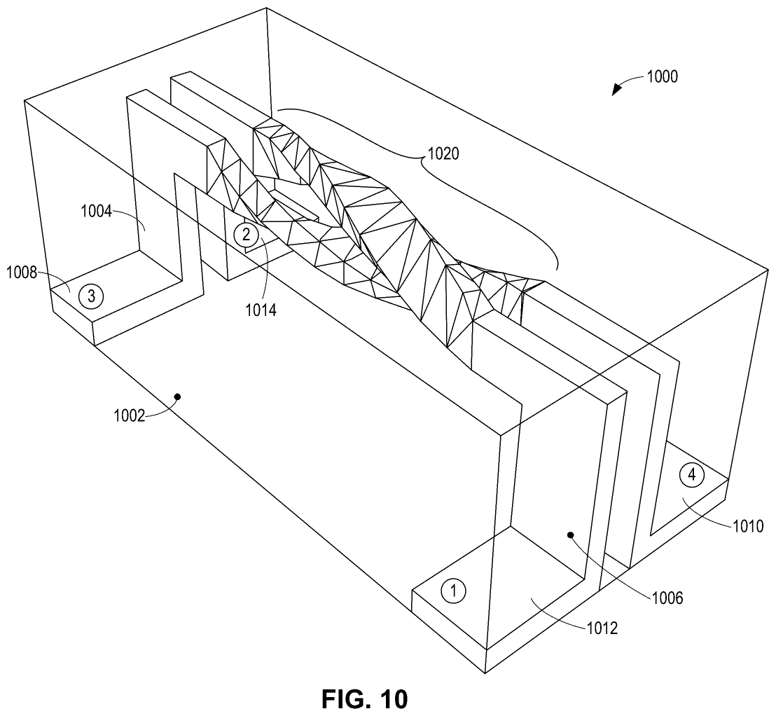

FIG. 10 is a block diagram of an example coupled inductor structure 1000 to reduce space consumption and reduce conductive routing from driver circuitry to inductor terminals to achieve inverse coupling. The illustrated example of FIG. 10 includes a platform 1002, a first conductor 1004, and a second conductor 1006. The first conductor 1004 includes a third terminal 1008 and a fourth terminal 1010. The second conductor 1006 includes a first terminal 1012 and a second terminal 1014. Each of the first conductor 1004 and the second conductor 1006 form a mutual inductance section 1020 between their respective terminals. Unlike the illustrated examples of FIG. 4, FIG. 6A, FIG. 6B, FIG. 7A and FIG. 7B, which include mutual inductance along a parallel plane, the illustrated example of FIG. 10 exhibits a helical geometry between the conductors as they propagate along a common plane.

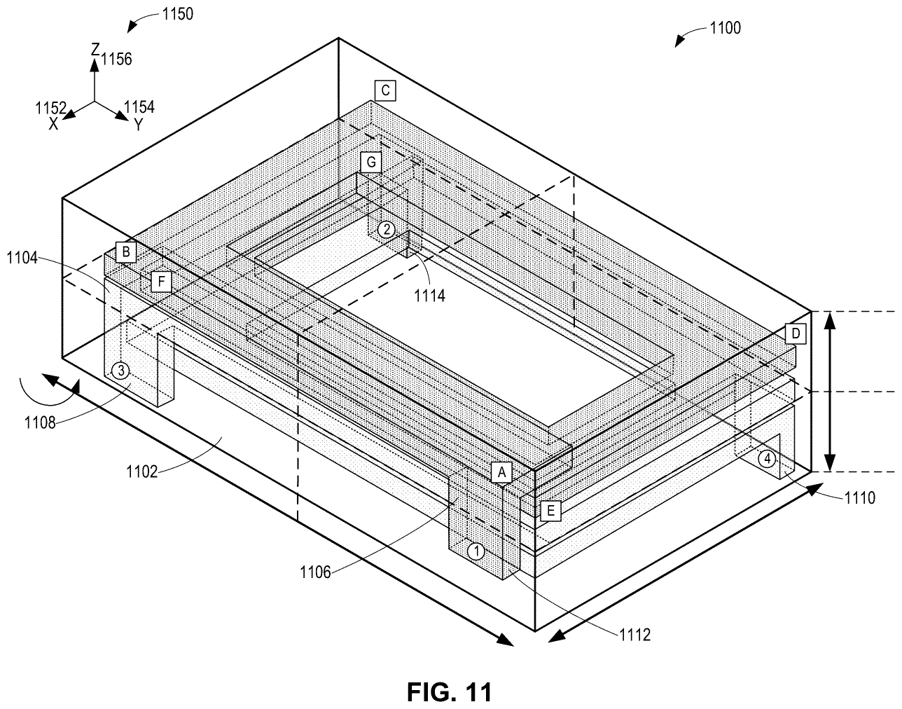

FIG. 11 is a block diagram of an example coupled inductor structure 1100 to reduce space consumption and reduce conductive routing from driver circuitry to inductor terminals to achieve inverse coupling. The illustrated example of FIG. 11 includes a cartesian coordinate orientation 1150, which includes an x-axis 1152, a y-axis 1154 and a z-axis 1156. The illustrated example of FIG. 11 includes a platform 1102, a first conductor 1104, and a second conductor 1106. The first conductor 1104 includes a third terminal 1108 (see encircled “3”) and a fourth terminal 1110 (see encircled “4”). The second conductor 1106 includes a first terminal 1112 (see encircled “1”) and a second terminal 1114 (see encircled “2”). Each of the first conductor 1104 and the second conductor 1106 form a mutual inductance along parallel traces between their respective terminals (e.g., between terminals 1 and 2 for the second conductor 1106, and between terminals 3 and 4 for the first conductor). In particular, the illustrated example of FIG. 11 shows that each conductor includes a trace forming a loop of one-and-a-half turns. While the example coupled inductor structure 1100 of FIG. 11 includes one-and-a-half turns, examples disclosed herein are not limited thereto.

In the illustrated example of FIG. 11, the second conductor 1106 begins a loop at the first terminal 1112 (see position “A”) and advances along a y-axis 1154 direction to position “B”. At position “B”, the second conductor 1106 turns 90 degrees along the plane defined by the y-axis 1154 and the x-axis 1152 and advances along the x-axis 1152 to position “C”. At position “C”, the second conductor 1106 turns 90 degrees along the plane defined by the y-axis 1154 and the x-axis 1152 and advances along the y-axis 1154 to position “D”. At position “D”, the second conductor turns 90 degrees along the plane defined by the y-axis 1154 and the x-axis 1152 and advances along the x-axis 1152 to position “E”. In particular, position “E” is where the second conductor 1154 has completed a first loop around the coupled inductor structure 1100. Stated differently, position “E” illustrates a point of a first full turn.

At position “E”, the second conductor turns 90 degrees along the plane defined by the y-axis 1154 and the x-axis 1152 and advances along the y-axis 1154 to position “F”. Note that positions “B” and “F” are substantially the same positions, except that position “F” is located along the z-axis 1156 at a position lower than that of position “B”. Similarly, the portion of the second conductor 1106 that advances between position “E” and position “F” is located along the z-axis 1156 position that is lower than the portion of the second conductor 1106 that advances between position “A” and position “B”. Stated differently, the portion of the second conductor 1106 between positions “A” and “B” overlaps the portion of the second conductor 1106 between positions “E” and “F”.

At position “F”, the second conductor 1106 turns 90 degrees along the plane defined by the y-axis 1154 and the x-axis 1152 and advances along the x-axis 1152 to position “G”. In particular, the portion of the second conductor 1106 between positions “F” and “G” is overlapped by the portion of the second conductor 1106 between positions “B” and “C”. Position “G” reflects a point at which the second conductor 1106 has looped one-and-a-half times, and terminates at the second terminal 1114. The first conductor 1104 also exhibits a similar overlapping path of a one-and-a-half times loop between the third terminal 1108 and the fourth terminal 1110.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example apparatus have been disclosed that enable mutual inductance between conductors to be routed through a structure to enable inverse coupling in a manner that permits drive circuitry to reside on a same side of a package (e.g., a base) containing the conductors. Disclosed apparatus improve the efficiency of using a computing device by reducing an amount of surface area required by inductors used by the computing device. Because drive circuitry can be located near terminals of inductive paths, leads lengths of wiring are reduced and/or otherwise minimized. Such reduction in lead lengths promotes improved signal interference isolation and power losses (e.g., I²R losses). Disclosed systems, apparatus, articles of manufacture, and methods are accordingly directed to one or more improvement(s) in the operation of a machine such as a computer or other electronic and/or mechanical device.

Example cross-connected coupled inductor structures are disclosed herein. Further examples and combinations thereof include the following:

Example 1 includes a coupled inductor comprising an enclosure having a left section and a right section, a front surface opposite a back surface, and a top surface opposite a bottom surface, a first plane of the front and back surfaces orthogonal to a second plane of the top and bottom surfaces, a first conductor having a first terminal proximate to an intersection of the bottom surface and the front surface of the right section of the enclosure, and a second terminal proximate to an intersection of the bottom surface and the back surface of the left section of the enclosure, and a second conductor having a third terminal proximate to an intersection of the bottom surface and the front surface of the left section of the enclosure, and a fourth terminal proximate to an intersection of the bottom surface and the back surface of the right section of the enclosure.

Example 2 includes the coupled inductor as defined in example 1, wherein the first conductor includes a first mutual inductance section and the second conductor includes a second mutual inductance section, the first and second mutual inductance sections having a length parallel to the first plane.

Example 3 includes the coupled inductor as defined in example 2, wherein the first and second mutual inductance sections are horizontally adjacent and separated by a gap.

Example 4 includes the coupled inductor as defined in any one or more of examples 1-3, wherein the first mutual inductance section is conductively coupled between the first terminal and the second terminal of the first conductor, and the second mutual inductance section is conductively coupled between the third terminal and the fourth terminal of the second conductor.

Example 5 includes the coupled inductor as defined in any one or more of examples 1-4, wherein the first, second, third, and fourth terminals are located in a bottom section of the enclosure, and the first and second mutual inductance sections are located in a top section of the enclosure.

Example 6 includes the coupled inductor as defined in any one or more of examples 1-5, wherein the first and second mutual inductance sections are vertically adjacent and separated by a gap.

Example 7 includes the coupled inductor as defined in any one or more of examples 1-6, wherein the first, second, third, and fourth terminals include a conductive interface, the conductive interface located on a bottom surface of the enclosure.

Example 8 includes the coupled inductor as defined in any one or more of examples 1-7, wherein the first and third terminals include a conductive interface located on the front surface.

Example 9 includes the coupled inductor as defined in any one or more of examples 1-8, wherein the second and fourth terminals include a conductive interface located on the back surface.

Example 10 includes the coupled inductor as defined in any one or more of examples 1-9, wherein the first and third terminals are conductively coupled to a driver source to facilitate inverse magnetic coupling between the first conductor and the second conductor.

Example 11 includes a device comprising a first conductor having a first terminal and a second terminal, a first crossover section between the first and second terminal, and a first mutual inductance section between the first and second terminal, and a second conductor having a third terminal and a fourth terminal, a second crossover section between the third and fourth terminal, and a second mutual inductance section between the third and fourth terminal.

Example 12 includes the device as defined in example 11, wherein the first terminal and the third terminal are driver terminals to cause inverse coupling between the first conductor and the second conductor.

Example 13 includes the device as defined in example 12, wherein the driver terminals are on a same side of the device.

Example 14 includes the device as defined in any one or more of examples 11-13, wherein the device includes a first side and a second side opposite the first side.

Example 15 includes the device as defined in any one or more of examples 11-14, wherein the first side includes the first terminal and the third terminal, and the second side includes the second terminal and the fourth terminal.

Example 16 includes the device as defined in example 15, wherein the first terminal and the second terminal are coupled to driver circuitry, the driver circuitry located proximate to the first side.

Example 17 includes the device as defined in any one or more of examples 11-16, wherein the first terminal of the first conductor is located on a driver side of the device and coupled to the first mutual inductance section, the first mutual inductance section is coupled to the first crossover section, and the first crossover section is coupled to the second terminal, the second terminal located opposite the driver side.

Example 18 includes the device as defined in any one of examples 11-17, wherein the third terminal of the second conductor is located on the driver side of the device and the second conductor is coupled to the second mutual inductance section, the second mutual inductance section is coupled to the second crossover section, and the second crossover section is coupled to the fourth terminal, the fourth terminal located opposite the driver side.

Example 19 includes the device as defined in any one of examples

11-18, wherein the first and third terminals are next to each other on the driver side of the device, and the second and fourth terminals are next to each other on the side opposite the driver side.

Example 20 includes the device as defined in any one of examples 11-19, wherein the first conductor and the second conductor form at least one of an orthogonal shape or a toroidal shape.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A coupled inductor comprising:
an enclosure having:
a left section and a right section;
a front surface opposite a back surface; and
a top surface opposite a bottom surface, a first plane of the front and back surfaces orthogonal to a second plane of the top and bottom surfaces;
a first conductor having:
a first terminal proximate to an intersection of the bottom surface and the front surface of the right section of the enclosure; and
a second terminal proximate to an intersection of the bottom surface and the back surface of the left section of the enclosure; and
a second conductor having:
a third terminal proximate to an intersection of the bottom surface and the front surface of the left section of the enclosure; and
a fourth terminal proximate to an intersection of the bottom surface and the back surface of the right section of the enclosure.

2. The coupled inductor as defined in claim 1, wherein the first conductor includes a first mutual inductance section and the second conductor includes a second mutual inductance section, the first and second mutual inductance sections having a length parallel to the first plane.

3. The coupled inductor as defined in claim 2, wherein the first and second mutual inductance sections are horizontally adjacent and separated by a gap.

4. The coupled inductor as defined in claim 2, wherein:
the first mutual inductance section is conductively coupled between the first terminal and the second terminal of the first conductor; and
the second mutual inductance section is conductively coupled between the third terminal and the fourth terminal of the second conductor.

5. The coupled inductor as defined in claim 4, wherein:
the first, second, third, and fourth terminals are located in a bottom section of the enclosure; and
the first and second mutual inductance sections are located in a top section of the enclosure.

6. The coupled inductor as defined in claim 2, wherein the first and second mutual inductance sections are vertically adjacent and separated by a gap.

7. The coupled inductor as defined in claim 1, wherein the first, second, third, and fourth terminals include a conductive interface, the conductive interface located on a bottom surface of the enclosure.

8. The coupled inductor as defined in claim 1, wherein the first and third terminals include a conductive interface located on the front surface.

9. The coupled inductor as defined in claim 1, wherein the second and fourth terminals include a conductive interface located on the back surface.

10. The coupled inductor as defined in claim 1, wherein the first and third terminals are conductively coupled to a driver source to facilitate inverse magnetic coupling between the first conductor and the second conductor.

11. A device comprising:
a first conductor having:
a first terminal and a second terminal;
a first crossover section between the first and second terminal; and
a first mutual inductance section between the first and second terminal; and
a second conductor having:
a third terminal and a fourth terminal;
a second crossover section between the third and fourth terminal; and
a second mutual inductance section between the third and fourth terminal.

12. The device as defined in claim 11, wherein the first terminal and the third terminal are driver terminals to cause inverse magnetic coupling between the first conductor and the second conductor.

13. The device as defined in claim 12, wherein the driver terminals are on a same side of the device.

14. The device as defined in claim 11, wherein the device includes a first side and a second side opposite the first side.

15. The device as defined in claim 14, wherein the first side includes the first terminal and the third terminal, and the second side includes the second terminal and the fourth terminal.

16. The device as defined in claim 15, wherein the first terminal and the second terminal are coupled to driver circuitry, the driver circuitry located proximate to the first side.

17. The device as defined in claim 11, wherein:
the first terminal of the first conductor is located on a driver side of the device and coupled to the first mutual inductance section;
the first mutual inductance section is coupled to the first crossover section; and
the first crossover section is coupled to the second terminal, the second terminal located diagonally opposite to the driver side.

18. The device as defined in claim 17, wherein:
the third terminal of the second conductor is located on the driver side of the device and the second conductor is coupled to the second mutual inductance section;
the second mutual inductance section is coupled to the second crossover section; and
the second crossover section is coupled to the fourth terminal, the fourth terminal located diagonally opposite to the driver side.

19. The device as defined in claim 18, wherein the first and third terminals are next to each other on the driver side of the device, and the second and fourth terminals are next to each other on the side opposite the driver side.

20. The device as defined in claim 11, wherein the first conductor and the second conductor form at least one of an orthogonal shape, circular shape or a toroidal shape.
